(19) United States
(12) Patent Application Publication
(10) Pub. No.: US 2025/0022093 A1
(43) Pub. Date: Jan. 16, 2025

(54) Method for constructing a mosaic image, and corresponding device and computer program

(71) Applicants: Université de Lorraine, NANCY (FR); Assistance Publique – Hôpitaux de Paris (APHP), PARIS (FR); Université Paris-Saclay, GIF-SUR-YVETTE (FR)

(72) Inventors: Dinh-Hoan Trinh, Vandoeuvre-Lès-Nancy (FR); Dominique Lamarque, Paris (FR); Thomas Bazin, Paris (FR); Christian Daul, Maxéville (FR)

(21) Appl. No.: 18/293,098

(22) PCT Filed: Jul. 21, 2022
(86) PCT No.: PCT/EP2022/070567

§ 371 Date: Sep. 27, 2024

(30) Foreign Application Priority Data
Jul. 30, 2021 (FR) FR2108318

(51) Int. Cl. G06T 3/4038

(52) U.S. Cl. CPC G06T 3/4038; G06T 2207/10068

(57) ABSTRACT

A method for constructing a mosaic image from a sequence of images of a hollow organ. The sequence of images originates from an endoscope inserted into the hollow organ. The method is implemented by an electronic device having a processor and a memory. Such a method includes: selecting images, from the sequence of images; providing a subset of images and a reference image among this subset of images; determining geometric links between the previously determined reference image and the images of the subset of images; and constructing the mosaic image from the reference image, at least some of the images of the subset of images and the geometric links of these images of the subset of images.

### FIELD OF THE INVENTION

The invention relates to a technique for processing images coming from a device for capturing images of a hollow organ. More particularly, the invention relates to the building of an image resulting from a combination of a plurality of images coming from a capture device, such as an endoscope, located in a hollow organ.

### PRIOR ART

In the medical field, endoscopes play an essential role for the inspection of the hollow organs and the cavities of the body. They provide high-resolution images with natural colours and textures required for a diagnosis, the monitoring of patients and operations.

In the industrial field, the endoscope allows to carry out an inspection by intrusion without damaging the inspection zone. In this industrial field, the endoscope is used in mechanics, aeronautics, railway, maritime and construction for the inspection of a hollow body or a pipe to look for a defect, for example such as welding defects.

However, the reduced field of view of endoscopes is a major limiting factor for an easy interpretation of scenes. More particularly, for example in the medical field, the limited fields of view of endoscopes and the lack of easy control of the trajectory of the instrument complicate the search for and the diagnosis of lesions on the epithelial walls of the hollow organs such as the stomach or the bladder.
The reduced field of view does not allow to locate the endoscope with respect to anatomical reference points and so the clinician cannot easily come back to a region of interest (Rol); this lack of location can also lead to gaps in the regions to be inspected (risk of omitting the visualisation of lesions);
Video-endoscopies, which are recorded during the examination of the patient, are in general difficult to use after the examination, when the endoscopist is no longer manipulating the instrument; this does not facilitate a second diagnosis (in particular by another doctor, or by the same doctor) after the examination;
After the examination, no discussion support is available for an exchange between specialists of various disciplines;
The monitoring of patients and the traceability of the examinations is difficult to carry out;
The identification of certain lesions is very often difficult during a conventional endoscopy since the latter are not very visible and/or very localised.

Moreover, numerous studies have documented a significant variability in the recognition of lesions between operators, or even for the same operator at several instants. There is therefore a significant need for techniques or methodologies that improve the quality of the recognition and of the diagnosis of lesions during a gastro-intestinal endoscopy.

Mosaicking techniques allow the calculation of panoramic images of an entire zone of interest which includes, for example, lesions and anatomical reference points.

### SUMMARY OF THE INVENTION

The method proposed by the inventors does not pose at least some of these problems of the prior art. Indeed, a method for building a mosaic image from a sequence S of images of a hollow organ is proposed, said sequence S of images coming from an endoscope inserted into the hollow organ, this method being implemented by an electronic device comprising a processor and a memory and characterised in that it comprises:
a step of selecting images, from said sequence S of images, delivering a subset of images S_{c} and a reference image I_{ref}^{c} among this subset of images S_{c};
a step of determining geometric links H between the reference image I_{ref}^{c} previously determined and the images of the subset of images S_{c};
a step of building the mosaic image from the reference image I_{ref}^{c}, at least some of the images of the subset of images S_{c} and the geometric links H of these images of the subset of images S_{c}.

Thus, it is possible to build a more faithful representation of the inside of the hollow organ while minimising the artefacts.

According to a specific feature, the step of selecting images comprises:
a step of determining, among the sequence S of images, the subset of images S_{c} corresponding to the convex envelope of the centres P={P₁, P₂, . . . , P_{N}} of the images of the sequence S of images; and
on the basis of this subset of images S_{c}, selecting the image I_{ref}^{c} that maximises the distance to the centre of the set of images of the sequence S of images.

Thus, the creation of the future mosaic image is facilitated by using images that are representative of the scope of the field of vision of the images of the sequence of images.

According to a specific feature, the step of determining a geometric link with the reference image I_{ref}^{c} comprises, for a current image Iᵢ belonging to the subset of images S_{C}, at least one step of calculating a homography H_{i→ref} between the reference image and the current image, said homography H_{i→ref} being determined according to a rate of superposition τ_{i,ref} between the pixels of the reference image I_{ref}^{c} and the pixels of the current image Iᵢ.

Thus, it is possible to determine the movements that are present in the subset of images.

According to a specific feature, when the rate of superposition τ_{i,ref} between the pixels of the reference image I_{ref}^{c} and the pixels of the current image Iᵢ is less than a predetermined value, said homography H_{i→ref} between the reference image and the current image is the result of a product of at least two intermediate homographies (H_{i→j}, H_{j→ref}) involving the use of at least one intermediate image Iⱼ.

Thus, it is possible to determine a path of movement, which allows to explain the link between images of the subset of images.

According to a specific feature, the step of building the mosaic image I^{mos} comprises at least one iteration of the following steps:
a step of selecting, in the subset of images S_{C}, the image Iₜ^{c} farthest from the reference image I_{ref}^{c};
a step of transforming the image Iₜ^{c} into the coordinate system of the reference image I_{ref}^{c} using the geometric link H_{i→ref} between the image Iₜ^{c} and the reference image I_{ref}^{c}, delivering a transformed image Iₖ^{c,trans}.
a step of excluding, on the basis of the transformed image Iₖ^{c,trans}, the pixels belonging to the mosaic image I^{mos} delivering an image to be combined Îₖ^{c,trans}.
a step of adding the pixels of the image to be combined Îₖ^{c,trans} to the mosaic image I^{mos};
a step of deleting the image Iₜ^{c} from the subset of images S_{C}.

Thus, the movements, in the form of mathematical transformations, previously determined are used to only add, to the mosaic image, the pixels that are not already previously known.

According to a specific feature, the step of excluding, on the basis of the transformed image Iₖ^{c,trans} the pixels belonging to the mosaic image I^{mos} delivering an image to be combined Îₖ^{c,trans} comprises the implementation of the following operation:

\hat{t}ₖ^{c,trans}=Iₜ^{c,trans}∩D(Iₜ^{c,trans}\I^{mos},se).
in which:
D is the morphological operator of dilation that uses a structuring element se;
\ is the exclusion operator; and
∩ is the intersection operator.

According to a specific feature, the step of adding the pixels of the image to be combined Îₖ^{c,trans} to the mosaic image I^{mos} comprises the implementation of the following operation:

I^{mos}←I^{mos}⊕Îₜ^{c,trans}
in which ⊕ translates the operator for blending the colours of superimposed pixels.

According to a specific feature, the sequence S of images of the hollow organ is obtained by the implementation of a plurality of steps of tracking homologous points of images acquired by an operator of the endoscope during the image captures carried out inside the hollow organ.

According to a specific feature, before the step of selecting images, it comprises a step of acquiring said sequence S of images using an endoscope inserted into the hollow organ, this step of acquiring said sequence S of images comprising:
a step of selecting an initial image, from said sequence S of images, displayed on a visualisation screen; and
   for each image subsequently selected, called current image:
a step of calculating homologous points between said current image and the preceding image;
a step of displaying a piece of data representative of the capture of the current image on the visualisation screen; and
a step of calculating and of displaying an approximate mosaic image; and
a step of adding said current image to said sequence S of images.

According to another aspect, the disclosure also relates to an electronic device for building a mosaic image from a sequence S of images of a hollow organ, said sequence S of images coming from an endoscope inserted inside the hollow organ. Such an electronic device comprises a processor and a memory and comprises:
means for selecting images, from said sequence S of images, delivering a subset of images S_{c} and a reference image I_{ref}^{c} among this subset of images S_{c};
means for determining geometric links H between the reference image I_{ref}^{c} previously determined and the images of the subset of images S_{c};
means for building the mosaic image from the reference image I_{ref}^{c}, at least some of the images of the subset of images S_{c} and the geometric links H of these images of the subset of images S_{c}.

According to a preferred implementation, the various steps of the methods according to the invention are implemented by one or more pieces of software or computer programmes, comprising software instructions intended to be executed by a data processor of a relay module according to the invention and being designed to control the execution of the various steps of the methods.

Consequently, the invention is also aimed at a programme, capable of being executed by a computer or by a data processor, this programme including instructions for controlling the execution of the steps of a method as mentioned above.

This programme can use any programming language, and be in the form of source code, object code, or intermediate code between source code and object code, such as in a partly compiled form, or in any other desirable form.

The invention is also aimed at an information support readable by a data processor, and including instructions of a programme as mentioned above.

The information support can be any entity or device capable of storing the programme. For example, the support can include a storage medium, such as a ROM, for example a CD-ROM or a microelectronic circuit ROM, or a magnetic storage medium, for example a mobile support (memory card) or a hard disk.

Moreover, the information support can be a transmittable support such as an electric or optical signal, which can be transported via an electric or optical cable, by radio or by other means. The programme according to the invention can be in particular downloaded on a network of the Internet type.

Alternatively, the information support can be an integrated circuit into which the programme is incorporated, the circuit being adapted to execute or to be used in the execution of the method in question.

According to one embodiment, the invention is implemented via software and/or hardware components. In this regard, the term “module” can correspond in this document both to a software component and to a hardware component or to a set of hardware and software components.

A software component corresponds to one or more computer programmes, one or more subprogrammes of a programme, or more generally to any element of a programme or of a piece of software capable of implementing a function or a set of functions, according to that which is described below for the module in question. Such a software component is executed by a data processor of a physical entity (terminal, server, gateway, router, etc.) and is capable of accessing physical resources of this physical entity (memories, recording media, communication buses, input/output electronic cards, user interfaces, etc.).

Likewise, a hardware component corresponds to any element of a hardware assembly capable of implementing a function or a set of functions, according to that which is described below for the module in question. This can be a hardware component that is programmable or with an integrated processor for the execution of software, for example an integrated circuit, a chip card, a memory card, an electronic card for the execution of a firmware, etc.

Each component of the system described above of course implements its own software modules.

The various embodiments mentioned above can be combined with each other for the implementation of the invention.

### DRAWINGS

Other features and advantages of the invention will appear more clearly upon reading the following description of a preferred embodiment, given as a simple illustrative and non-limiting example, and of the appended drawings, in which:

FIG. 1 describes the general principle of the invention;

FIG. 2 describes the various steps of an image acquisition method in an exemplary embodiment;

FIG. 3 illustrates a convex envelope in one example;

FIG. 4 illustrates a mosaic image obtained by the implementation of the building method in an exemplary embodiment;

FIG. 5 succinctly illustrates a device capable of implementing the system according to the invention.

### DESCRIPTION OF AN EMBODIMENT

### Reminders

A mosaicking technique is proposed in order to present the information contained in the images of a sequence of images acquired during the endoscopy in a form easier to use and more compact. This technique involves calculating geometric movements between images of the sequence of images and replacing these images in a single reference frame to generate a “panoramic” image. The operator can then navigate in this mosaic image and orient himself more easily to for example find region of interests shared by another mosaic image created earlier or to identify lesions or pre-lesions. Since endoscopic images are often not very contrasted and textured a specific registration algorithm is presented. The general principle of the disclosure involves the implementation of a method in several steps, implemented in parallel (or sequentially): a step of guided acquisition of the images of the sequence of images and on the basis of the sequence of images acquired, a step of building a mosaic image.

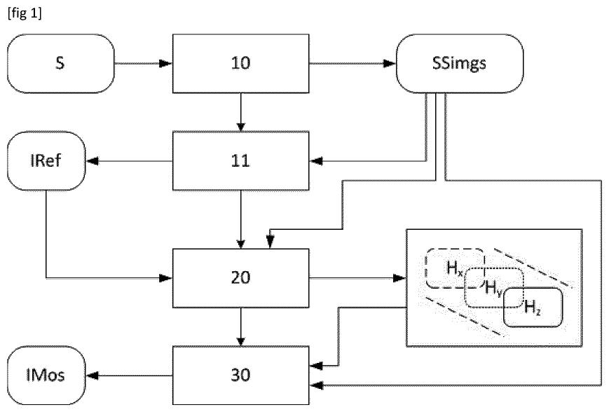

According to the present disclosure, and in relation to FIG. 1, the building of the mosaic image comprises, on the basis of the sequence of images acquired:
a step 10 of selecting images, from said sequence of images S, delivering a subset of images SSimgs and a step 11 of determining a reference image Ref among this subset of images SSimgs;
a step 20 of determining a geometric link H, . . . between the reference image Ref previously determined and at least some of the images of the subset of images SSimgs; and
a step 30 of building the mosaic image IMos from said at least some of the images of the subset of images SSimgs.

According to the present disclosure, more particularly, the mosaic image is built from a subset of images of the sequence of acquired images, this subset of images being selected to minimise the distortions of pixels and of colours. More particularly, the determination of the geometric link between the reference image and the images of the subset of images comprises two classes of distinct actions: on the one hand the calculation of transformations between the images of the subset of images and on the other hand the selection in the subset of images of images that are used to build the mosaic image. Even more particularly, the images selected in the subset of images are chosen so as to minimise the number of images to be used to build the mosaic image.

In other words, and counter-intuitively, instead of using as many images as possible to be able to build the mosaic image, the inventors had the idea of using on the contrary as few images as possible in order for only the relevant information (i.e. relevant data of pixels) to be inserted into the mosaic image during its construction. In this way, according to the invention, introducing, into the mosaic image, too much “blended” data, that is to say data that comes from blends of pixels coming from several images, is avoided. Indeed, since the goal of the mosaic image is to have available an image representative of the cavity photographed several times by the endoscope, the method of the present disclosure seeks to minimise the calculations carried out on the various pixels, in order to mainly insert into the mosaic image “original” pixels, which come directly from images captured by the endoscope, and not “calculated” pixels, coming from a fusion of information between pixels of two (or more) images. To do this, a method for progressive building of the mosaic image is thus implemented, a method in which, on the basis of the reference image determined at the beginning of the process, the various images of the subset of images are used to increase the size of the reference image, this increase involving inserting on the edges of the reference image pixels coming from at least some images of the subset of images (and more generally from most of the images of the subset of images). To have available satisfactory images, in this subset of images, the inventors had the idea to take as a starting point the sequence of images captures by the endoscope and to reduce this sequence of images to arrive at the subset of images that comprises the images that are used to build the mosaic image. Thus, on the basis of the sequence of images captured by the endoscope, a first step of determining a convex envelope is implemented, in which the images representing the vertices of the convex envelope are preserved and form the subset of images. The reference image is selected from this subset of images.

Then, a geometric link, in the form of one or more homographies, is calculated between each image of the subset of images (e.g. each image of the convex envelope) and the reference image. This geometric link is calculated so that the transformation between the reference image and an image of the convex envelope is the product of at least one homography between this image of the convex envelope and the reference image.

Finally, several iterations of building the mosaic image are implemented to, on the basis of the reference image, augment the latter, by starting from the image of the subset that is the farthest from the reference image, by adding the pixels of this image (the farthest from the mosaic image) and so on by decreasing distance from the reference image. When necessary (for example to fill in empty zones of the mosaic image), images from inside the convex envelope (i.e. images that do not belong to the subset of images) are used: this therefore means calculating homographies for these images located inside the convex envelope, and on the basis of these new homographies, filling in the empty spaces with these transformed images coming from inside the convex envelope.

Thus, after this implementation, a mosaic image is available, coming from the sequence of images of the endoscope, in which a majority of the pixels come from an original image captured by the endoscope. Thus, the technique disclosed allows to carry out a mosaicking in two dimensions of a video sequence of images not very textured, with variable textures and/or without significant changes in illumination. This technique allows more particularly to carry out a mosaicking in the context of a study of a hollow organ, for example such as a bladder, a stomach or lungs, or any other hollow volume, whether in the medical field or in the industrial field. The images processed in the context of the present technique generally come from an endoscope. This technique has numerous advantages, among which:
Assistance is proposed to the operator to carry out in real time an acquisition of a video sequence that allows to cover without gaps a Rol without modifying the medical procedure.
An enlarged field of view (approximate mosaic) is proposed in real time, which allows to visualise zones with possible gaps (non-scanned Rols).
The calculation of the precise mosaic image (without geometric discontinuity and textures in the Rol) is carried out in less than one minute in the case of the pyloric antrum (zone in which lesions appear in the stomach). A second diagnosis is possible during the examination and the zone can be reinspected if necessary, by visualising the mosaic image.
A mosaic can be manufactured even if very few textures or structures are visible in the images (this is the case in white light in particular in gastroscopy).
A mosaic can be manufactured for very different textures, which makes the mosaicking possible in other modalities, like chromo-endoscopy video (green/blue NBI or BLI according to the manufacturer) which is often used as a complement in certain types of examinations.
The mosaicking method (with all its advantages of assisting the acquisition, etc.) can be extended to white-light or fluorescence cystoscopy.
Comparing two mosaics manufactured for the same patient on the basis of video sequences acquired at a time interval of several weeks, month or years allow to monitor the change in a lesion and facilitates the monitoring of the patient (non-existent in endoscopy).
Archiving a mosaic ensures a traceability currently non-existent in gastroscopy.
A mosaic is a new exchange support for clinicians of various specialities.

In the rest of the document, exemplary embodiments of the steps introduced above are more particularly described. It is obvious that these explanations form examples and that in particular the methodologies used, in particular to acquire the images at the moment of use of the endoscope or to determine the convex envelope from the sequence of acquired images, can be replaced by equivalent methods providing equivalent results. It is also understood that the method described can be implemented differently according to the operational implementation conditions: for example, instead of as described above calculating the transformations H only for the images of the convex envelope, it is totally possible to calculate the transformations for the totality of images of the sequence of images S and to use these precalculated transformations H afterwards. Likewise, as will be clear below, all of the results of the calculations carried out, and in particular the results of calculations of transformation H, are stored in memory. This recording pursues two goals: the first is relative to the possibility, as explained below, of going, during the viewing of the images, from the mosaic image to the original image of the image sequence and vice versa; the second goal relates to the necessity of being able to explain the calculations carried out, in the context for example of a qualitative analysis of the results produced, in particular for purposes of improving the processing of the images, on a greater cohort of images.

### Assisting the Acquisition of an Image Sequence in an Exemplary Embodiment

Here an exemplary embodiment of obtaining an image sequence is presented in a first exemplary embodiment. According to the present technique, in this exemplary embodiment, it is sought to make it so that the image sequence acquired is as usable as possible for the implementation of the following processing steps. Of course, this acquisition assistance is optional and only allows to prepare a sequence of images that facilitates the later processing. It is totally possible to not implement this acquisition assistance and to use a sequence of images acquired normally (i.e. without acquisition assistance). The implementation of an acquisition assistance simply allows to increase the performance of the following steps.

In any case, in this example, the acquisition of a sequence of images comprises two aspects: a first aspect relating to the refining, in real time, of information intended for the operator; and a second aspect relating to the addition of information relative to the capture of the image sequence.

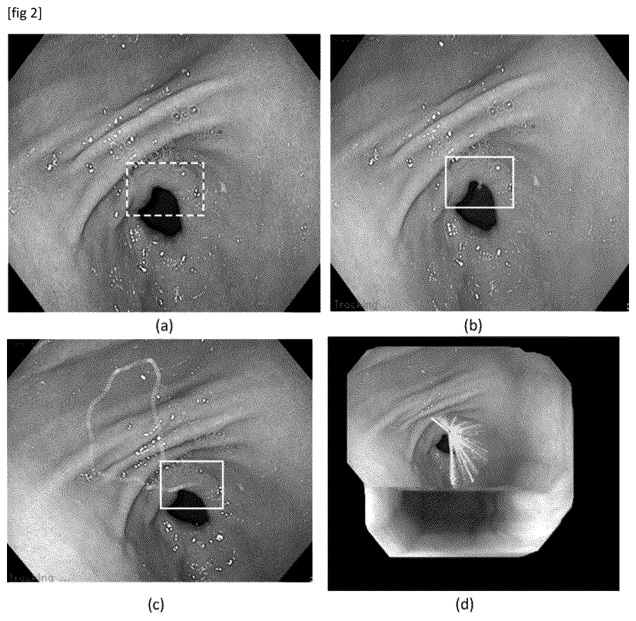

Thus, for example in the case of a gastric examination, in the video displayed in a standard manner on a screen in real conditions, the operator selects any zone, for example rectangular, in an image that he will have chosen (see the “white dotted” frame in FIG. 2.(a)). This rectangular zone defines the zone of the pyloric antrum that must be tracked in the following images. In FIG. 2.(b), the “white” circles (visible in the centre of the solid “white” rectangle) give, for three images, the successive positions of the centres of the rectangular regions tracked and placed in the current image of the video sequence. FIG. 2.(c) shows the trajectory of the tracking of the zone of interest after the stoppage of the tracking (and image capture) process by the operator. The latter decides on the stoppage of the tracking using the video sequence of FIG. 2.(d) displayed in real time on the screen. For each new image, the “white” segment is defined by two points: the centre of the rectangular zone of the starting image and the centre of the tracked zone in the current image. This representation facilitates an optimal acquisition of the pyloric antrum: ideally the “white” segments must be as long as possible and go completely around the initial point of FIG. 2.(a) to maximise the size of the surface acquired and minimise the risks of gaps. These radii are superimposed on an approximate mosaic which is also displayed to assist the operator in estimating the zone covered during their examination.

In other words, in this step, the operator is assisted in capturing, via the endoscope, images that are as usable as possible for the later steps of building the (definitive) mosaic image. This assistance is provided by defining a starting image, on the basis of the zone initially selected, then by marking, on the display, the centres of the following images acquired by the endoscope (“white” circles), while dynamically building (i.e. in real time) an approximate mosaic image and while showing the quality of the capture carried out (using indications placed on the approximate mosaic image).

First of all, the display of the centres of the images acquired by the endoscope (white circles) is implemented by carrying out a tracking of homologous points according to two complementary methods:
The first method (fast) is a method for tracking homologous points in two rectangular zones using a sparse optical flow method, for example such as the method of Lucas and Kanade (1981). This method has the advantage of being fast, but it requires zones with contrasted textures and its efficiency decreases when there are significant changes in illumination between the images. It is however implemented initially: when a number of pairs of homologous points obtained with this technique exceeds or is equal to a predetermined parameter (the value of which is between 4 and 10), then it is considered that this first fast method is sufficient and the movement between the two images for which this method is implemented (two yellow centres of the region of interest) is calculated from the average movement (average vector) of the homologous points.
The second method is slower but more efficient. This second method is implemented as the second choice when the number of pairs of homologous points between two successive images, obtained by the first method, is located below the predetermined parameter (that is to say below 4 to 10, depending on the value of this parameter). This is a dense optical flow method that is used to find matches in regions with few textures and/or subjected to large changes in illumination. For example the method D. H. Trinh and C. Daul (2019) is used. For this method, the homologous points are sought in a neighbourhood of 200 by 200 pixels centred on the zone marked by the clinician and which moves during the sequence. The movement between two images is given by the average vector of the movements between homologous points of the two images.

Once the tracking of the homologous points has been carried out, and a new image is acquired, the approximate mosaic is completed only by the pixels that enlarge the approximate mosaic image being built (at first the approximate mosaic image corresponds to the first image which grows successively by the addition of other pixels) and the segment connecting the centre of the first rectangular zone to that of the current image is drawn on the approximate mosaic image.

When the operator has finished the image capture of the volume, the following are available:
a sequence S of N images: S={I₁, I₂, . . . , I_{N}}
a vector v_{n,n+1} of movement between the position of the centres Pₙ and Pₙ₊₁ of the images Iₙ and Iₙ₊₁ (and by extension a vector of movement between any image pair of the sequence of images);
by taking the coordinate system of the image I₁ as a reference, the position of the centres Pₙ in the 2D plane of the mosaic: Pₙ₊₁=Pₙ+v_{n,n+1}, with P₁=(0,0).
all of the centres P={P₁, P₂, . . . , P_{N}} of the sequence of images S={I₁, I₂, . . . , I_{N}}.

As explained above, it is totally possible to have this data available by methods other than those described above.

### Selection of Images and Search for a Reference Image in an Exemplary Embodiment

As explained above, the selection of images among the sequence of images pursues the goal of limiting the number of images to be used to build the final mosaic image. The inventors have considered that a reduced number of images allowed to obtain a mosaic image of better quality and more representative of an overall view of the inside of the cavity. To do this, a method that delivers a subset (the smallest possible) of the images of S that cover the entire surface of interest and the reference image (which is used as the coordinate system for the mosaic image) is applied, the images of this subset allowing to minimise the geometric (distortions) and colour discontinuities during the placement of the pixels in the mosaic image. To do this, this selection step comprises:
a step of determining, among the sequence of images S, an image subset corresponding to the convex envelope of the centres P={P₁, P₂, . . . , P_{N}} of the images of the set of images; and
from this subset of images, selecting the image that maximises the distance to the centre of the set of images of the sequence of images (i.e. the one that is the farthest from the average centre of the set of images).

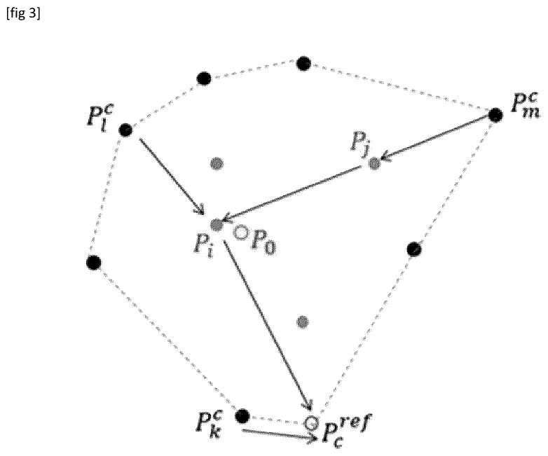

In other words, to obtain this subset, in this exemplary embodiment, the convex envelope (see FIG. 3) of the trajectory in two dimensions (2D) of the centres P={P₁, P₂, . . . , P_{N}} is determined in order to select the images that best cover the surface of the cavity (for example of the organ) to be visualised. Several methods for determining the convex envelope can be implemented, for example such as the method described by D. G. Kirkpatrick and R. Seidel (1986).

The set of the vertices P_{c}={P₁^{c}, P₂^{c}, . . . , P_{K}^{c}} of this obtained envelope allows to select the K<=N images located at the periphery of the zone scanned by the endoscope, and thus to maximise the size of the future mosaic image. The set of the K images thus selected constitutes the subset and is labelled S_{c}={I₁^{c}, I₂^{c}, . . . , I_{K}^{c}}. In FIG. 3, the images of the subset are those presented by the black discs.

Among the images selected, that which is the farthest from the centre P₀ (average position of the images of the sequence of images S) minimises the distortions if it is taken as a reference.

The reference image I_{ref}^{c}, the position of the centre of which in the 2D plane is P_{ref}^{c}, is determined by maximising the distance P̅_̅{̅r̅e̅f̅}̅^̅{̅c̅}̅P̅₀̅:

$$\overline{{P}_{ref}^{c} {P}_{0}} = max {\{ \overline{{P}_{k}^{c} {P}_{0}} \}}_{k = 1}^{K} with {P}_{0} = \frac{1}{N} {\sum }_{i = 1}^{i = N} {P}_{i}$$

Thus, after this implementation, a reference image and a subset of images that will be used to progressively build the mosaic image are available. Before this, however, it is necessary to calculate the transformations between the images of the convex envelope to allow to carry out the filling of the mosaic image.

### Determination of Geometric Transformations in an Exemplary Embodiment

As explained, this step involves calculating the geometric transformations between the reference image and each image of the convex envelope. These transformations are necessary to allow the adjustment of the pixels on the mosaic image. Thus, a search for the geometric link between the reference image and each image Iₖ^{c} of S_{c} is carried out to be able to then transform these images of S_{c} before adding a part thereof to the mosaic image.

In general, the geometric link between two images Iᵢ and Iⱼ is given by a homography H_{i→j}, the parameters tₓ and t_{y} of which correspond to a 2D translation, the four parameters a₁₁, a₁₂, a₂₁ and a₂₂ depend on a rotation in the image plane and on a scale factor while a₃₁ and a₃₂ are the perspective parameters:

$$( \begin{matrix}{α}_{ij} \cdot {x}_{j} \\ {α}_{ij} \cdot {y}_{j} \\ {α}_{ij}\end{matrix} ) = {\underbrace{( \begin{matrix}{a}_{11} & {a}_{12} & {t}_{x} \\ {a}_{21} & {a}_{22} & {t}_{y} \\ {a}_{31} & {a}_{32} & 1\end{matrix} )}}_{{H}_{i \to j}} ( \begin{matrix}{x}_{j} \\ {y}_{i} \\ 1\end{matrix} )$$

The coordinates (xᵢ, yᵢ) and (xⱼ, yⱼ) are those of the homologous pixels of the images Iᵢ and Iⱼ and the parameter αᵢⱼ is entirely defined for the pixels i and j by the values of the coefficients a₃₁ and a₃₂. The matching between the homologous points of the images Iᵢ and Iⱼ is obtained for example using the dense optical flow method presented above in the obtaining of the images of the sequence of images. The parameters of the matrix are determined using the RANSAC method of rejecting outlier points that takes this homography as a model (Martin A. Fischler and Robert C. Bolles, 1981).

To be able to calculate a homography connecting Iᵢ and Iⱼ, there must be a minimum overlap between the two images. This overlapping condition is verified using the following relation:

$$\{ \begin{matrix}- W < {v}_{k}^{x} < W \\ - H < {v}_{k}^{y} < H \\ {τ}_{i , j} = ( W - \vert {v}_{ij}^{x} \vert ) ( H - \vert {v}_{ij}^{y} \vert ) \geq \frac{WH}{2}\end{matrix}$$

where
W and H are the width and the height of the image;
(vᵢⱼ^{x}, vᵢⱼ^{y}) are the components of the vector P̅ᵢ̅P̅ⱼ̅, connecting the centres Pᵢ and Pⱼ of the images Iᵢ and Iⱼ;
WH/2 a minimum overlapping threshold; and
τ_{i,j} the surface area of overlapping in pixels.

While the first two lines of the system of equations allow to verify that two images have a shared part, the third line allows to measure an amount of superposition τ_{i,j} that must be greater than half of the surface area in pixels of the images.

FIG. 3 illustrates various situations according to the result of the test of superposition of the images.
when a vertex Pₖ^{c} of the envelope and the reference vertex P_{ref}^{c} have a τ_{k,ref} at least equal to WH/2, a single homography H_{k→ref} allows to create the link between the pixels of the two images Iₖ^{c} and I_{ref}^{c}.
when a vertex Pₗ^{c} of the envelope and the reference vertex P_{ref}^{c} have a τ_{l,ref} smaller than WH/2, then the centre Pᵢ of the image closest to P₀ is used. If both vectors \vec{PₗPᵢ} and \vec{PᵢP_{ref}} verify the superposition condition (τ_{l,i}>WH/2 and τ_{i,ref}>WH/2) then the product H_{l→ref}=H_{i→ref}H_{l→i} of the homographies H_{l→i} and H_{i→ref} allows to create the link between the pixels of the two images Iₗ^{c} and I_{ref}^{c}.
when the image closest to P₀ is not sufficient to create the bridge between a vertex and the reference image, other intermediate images are used to create the link between the pairs of images, the translation vector of which has the largest norm. This is the case, in FIG. 3, of the vector \vec{Pₘ^{c}Pᵢ} where the image represents a new bridge leading to τ_{m,j}>WH/2 and τ_{j,i}>WH/2.

The homography H_{m→ref}=H_{i→ref}H_{j→i}H_{m→j} allows to create the link between the pixels of the images Iₘ^{c} and I_{ref}^{c}.

In other words, for each vertex of the convex envelope, the vectors of movement between the images are iteratively divided using intermediate images so that a product of homographies can create the link between an image of a vertex of the convex envelope and the reference image P_{c}^{ref}. This algorithm, by minimising the number of images to be registered as well as the trajectories of images that cross, allows to minimise the geometric distortions (visible in the form of discontinuities of textures) in the mosaic image.

After this step, a set of homographies, usable to carry out the transformations of the images of the convex envelope in order to create the mosaic image from the reference image P_{c}^{ref}, is available.

### Building the Mosaic Image in an Exemplary Embodiment

By having the images of the envelope and the transformations of these images with respect to the reference image, it is thus possible to build the mosaic image.

In this exemplary embodiment, the initial mosaic image I^{mos} corresponds to the image I_{ref}^{c}. The reference point of the mosaic image I^{mos} is defined by the coordinate system of the reference I_{ref}^{c}. The images Iₖ^{c} corresponding to vertices Pₖ^{c} of the convex envelope are preferably used to build the mosaic. The other images (located inside the convex envelope) are optionally used to fill gaps in the mosaic after having used all the images Iₖ^{c}.

The building of the mosaic starts by the search for the image Iₜ^{c} farthest from the reference I_{ref}^{c}. It is found by maximising the distance:

\vec{P_{ref}^{c}Pₜ^{c}}=max{P_{ref}^{c}Pₖ^{c}|Pₖ^{c}∈P_{c}}.

After the selection of the image Iₜ^{c}, the vertex Pₜ^{c} is removed from the set P_{c}. The positions of the pixels of Iₜ^{c} are then expressed in the reference frame of the mosaic using the homography H_{k,ref}. This transposed image Iₖ^{c,trans} then allows to grow the mosaic as follows:

I^{mos}←I^{mos}⊕Îₜ^{c,trans}
where ⊕ translates the blending (blending of the colours of the superimposed pixels) operator and the image Îₖ^{c,trans} is defined by:

Îₜ^{c,trans}=Iₜ^{c,trans}∩D(Iₜ^{c,trans}\I^{mos},se).

In this equation D is the morphological operator of dilation that uses the structuring element se.

The non-null pixels of the image Îₜ^{c,trans} those of the image Iₜ^{c,trans} which are not superimposed by the mosaic I^{mos} and completed by the pixels of a region of reduced size shared between the images I^{mos} and Iₜ^{c,trans} used during the blending.

At each iteration of the process that follows the following are implemented:
the image Îₜ^{c,trans} with the least overlapping with I^{mos} is selected and its pixels are used to enlarge the mosaic using the two preceding equations, and
the image Îₜ^{c,trans} used is removed from the set S (S=S\Iₜ^{c,trans}).

There is a region having a reduced size located at the border of the mosaic image I^{mos} and of the pixels of Îₜ^{c,trans} that are added (edges one pixel thick). A dilation is carried out with the structuring element se: in this region of the mosaic, a “small region”, the thickness of which is that of the structuring element se, is created to carry out the blending. According to the exemplary embodiments, the structuring element se has a more or less reduced size. It corresponds to a binary mask (which allows to take into account the neighbourhood of the pixels) and takes for example the form of a square of several pixels to several tens of pixels per side (for example 70). Moreover, the edge one pixel thick that is dilated by the structuring element se only forms the shared region in which a transition without discontinuity of colour is ensured. The pixels added to the mosaic for each image go well beyond this single small shared transition region.

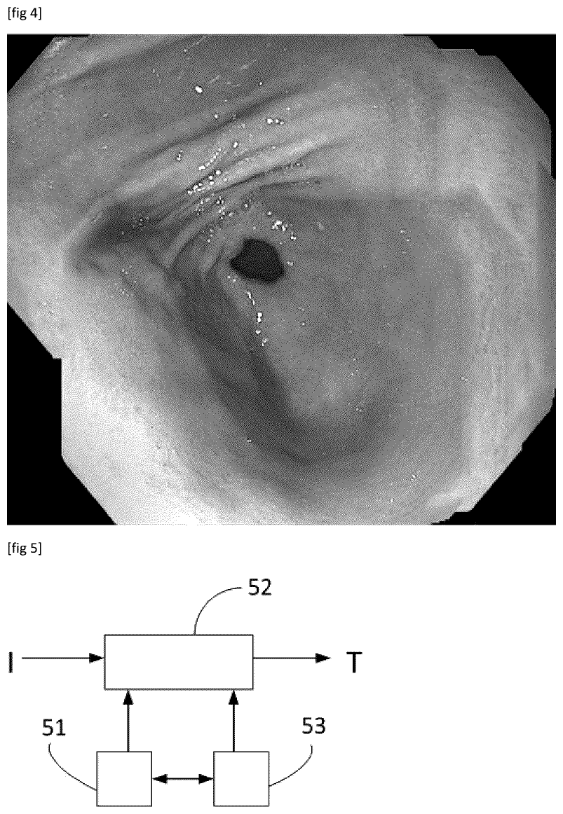

As illustrated in FIG. 4, the visual cohesion of the mosaic is maximised since the discontinuities caused by the transitions between pixels of various images are minimised.

### Navigation Between the Mosaic Image and the Original Images of the Sequence of Images and Vice Versa

Via the technique described above, the inventors have calculated geometric links between the individual images of the sequence of images S acquired by the operator of the endoscope and the mosaic image produced. These geometric links can be used, a posteriori, to go back and forth between the mosaic image and the original images having allows to obtain this mosaic image. In the case of a medical examination, such a possibility is of interest in that it allows for example to notice lesions or pre-lesions and to allow the inspection of more precise zones a posteriori.

Thus, let there be a region centred on a pixel pₖ^{cr}=(xₖ^{cr}, yₖ^{cr}) in the image Iₖ of the sequence of images (cr=region centre). By supposing the path and the known (since previously calculated and recorded at the same time as the mosaic image) corresponding homographies between the image Iₖ and the reference image I_{ref}^{c} of the mosaic, the position of the centre (pixel p_{ref}^{cr}=(x_{ref}^{cr}, y_{ref}^{cr})) of the region of interest can be calculated in the mosaic image using a product of homographies:

$$( \begin{matrix}{α}_{k , ref {x}_{ref}^{cr}} \\ {α}_{k , ref {y}_{ref}^{cr}} \\ {α}_{k , ref}\end{matrix} ) = {\underbrace{{H}_{n \to ref} {H}_{m \to n} {H}_{l \to m} {H}_{k \to 1}}}_{{H}_{k \to ref}} ( \begin{matrix}{x}_{k}^{cr} \\ {y}_{k}^{cr} \\ 1\end{matrix} )$$

In this example the path consists of the images Iₖ→Iₗ→Iₘ→Iₙ→I_{ref}^{c} geometrically linked by the homographies H_{k→l}, H_{m→n}, H_{l→m} and H_{n→ref} respectively. The parameter α_{kref} is entirely defined for each pixel by the perspective coefficients a₃₁ and a₃₂ of the four homographies. If a region is delimited by a polygon in the image Iₖ, the vertices of this polygon can be brought in the same way back into the reference frame of the mosaic image, to thus allow the inspection of this region in the mosaic image to have available an overall view of this region. The inverse is also true: starting from a region delimited by a polygon in the mosaic image, it is possible to go back to determine the images that were used to end up with this region and allow an inspection of these images.

Thus, as this is understood, in addition to the operations described above to build the mosaic image, the steps of the methods also comprise recordings, in memory, of the values of the parameters (in particular of the values of the homographies) allowing to go from an image of the sequence of images to the mosaic image and vice versa.

### Other Features and Advantages

In relation to FIG. 5, a simplified architecture of an electronic execution device capable of carrying out the processing and the execution of code according to at least one of the methods described above is presented. An electronic execution device comprises a memory 51 (and/or optionally secured and/or two separate memories, one secured and the other not), a processing unit 52 equipped for example with a microprocessor (and/or optionally secured and/or two separate processors, one secured and the other not), and controlled by the computer programme 53, implementing all or a part of the methods as described above. In at least one embodiment, the invention is at least partly implemented in the form of an application installed on this device. A data processing device for the implementation of functions of processing the sequence of images S coming from an endoscope, which comprises a processor 52, a memory 51 and a set of processing modules, implemented in a programme, is thus available. The device implements a current processing module of the set of processing modules, said current processing module belonging to the group comprising:
means for selecting images, from said sequence S of images, delivering a subset of images S_{c} and a reference image I_{ref}^{c} among this subset of images S_{C};
means for determining geometric links H between the reference image I_{ref}^{c} previously determined and the images of the subset of images S_{c};
means for building the mosaic image from the reference image I_{ref}^{c}, at least some of the images of the subset of images S_{C} and the geometric links H of these images of the subset of images S_{C}.

For the execution of the functions that are assigned to it, the device also comprises the means for implementing all of the steps mentioned above, either in hardware form, when specific components are dedicated to these tasks, or in software form in connection with one or more micro-programmes being executed on one or more processors of the execution device.

1. A method comprising:
building a mosaic image from a sequence S of images of a hollow organ, said sequence S of images coming from an endoscope inserted into the hollow organ, the building being implemented by an electronic device comprising a processor and a memory and comprising:
selecting images, from said sequence S of images, delivering a subset of images S_{C} and a reference image I_{ref}^{c} among this subset of images S_{c};
determining geometric links H between the reference image I_{ref}^{c} previously determined and the images of the subset of images SC; and
building the mosaic image from the reference image I_{ref}^{c}, at least some of the images of the subset of images SC and the geometric links H of these images of the subset of images SC.

2. The method according to claim 1, wherein selecting images comprises:
determining, among the sequence S of images, the subset of images SC corresponding to the convex envelope of the centres P={P₁, P₂, . . . , P_{N}} of the images of the sequence S of images; and
on the basis of this subset of images SC, selecting the image I_{ref}^{c} that maximises a distance to a centre of the set of the images of the sequence S of images.

3. The method according to claim 1, wherein the determining a geometric link with the reference image I_{ref}^{c} comprises, for a current image Iᵢ belonging to the subset of images S_{C}, at least one step of calculating a homography H_{i→ref} between the reference image and the current image, said homography H_{i→ref} being determined according to a rate of superposition τ_{i,ref} between the pixels of the reference image I_{ref}^{c} and the pixels of the current image Iᵢ.

4. The method according to claim 3, in response to the rate of superposition τ_{i,ref} between the pixels of the reference image I_{ref}^{c} and the pixels of the current image Iᵢ being less than a predetermined value, said homography H_{i→ref} between the reference image and the current image is the result of a product of at least two intermediate homographies (H_{i→j}, H_{j→ref}) involving the use of at least one intermediate image Iⱼ.

5. The method according to claim 1, wherein building the mosaic image I^{mos} comprises at least one iteration of the following steps:
a step of selecting, in the subset of images S_{C}, the image Iₜ^{c} farthest from the reference image I_{ref}^{c};
a step of transforming the image Iₜ^{c} into the coordinate system of the reference image I_{ref}^{c} using the geometric link H_{i→ref} between the image Iₜ^{c} and the reference image I_{ref}^{c}, delivering a transformed image Iₖ^{c,trans};
a step of excluding, on the basis of the transformed image Iₖ^{c,trans}, the pixels belonging to the mosaic image I^{mos} delivering an image to be combined Îₖ^{c,trans};
a step of adding the pixels of the image to be combined Îₖ^{c,trans} to the mosaic image I^{mos};
a step of deleting the image Iₜ^{c} from the subset of images SC.

6. The method according to claim 5, wherein the step of excluding, on the basis of the transformed image Iₖ^{c,trans}, the pixels belonging to the mosaic image I^{mos} delivering an image to be combined Îₖ^{c,trans} comprises implementation of the following operation:
Îₜ^{c,trans}=Iₜ^{c,trans}∩D(Iₜ^{c,trans}\I^{mos},se).
in which:
D is a morphological operator of dilation that uses a structuring element se;
\ is an exclusion operator; and
∩ is an intersection operator.

7. The method according to claim 5, wherein the step of adding the pixels of the image to be combined Îₖ^{c,trans} to the mosaic image I^{mos} comprises implementation of the following operation:
I^{mos}←I^{mos}⊕Îₜ^{c,trans}
in which ⊕ translates the operator for blending the colours of superimposed pixels.

8. The method according to claim 1, wherein the sequence S of images of the hollow organ is obtained by implementing a plurality of steps of tracking homologous points of images acquired by an operator of the endoscope during image captures carried out inside the hollow organ.

9. The method according to claim 1, wherein the method comprises, before selecting images, acquiring said sequence S of images using the endoscope inserted into the hollow organ, this step of acquiring said sequence S of images comprising:
displaying the sequence S of images on a visualisation screen;
selecting an initial image, from said sequence S of images, displayed on a visualisation screen; and
for each image subsequently selected, called current image:
calculating homologous points between said current image and the preceding image;
displaying a piece of data representative of a capture of the current image on the visualisation screen; and
calculating and displaying an approximate mosaic image; and
adding said current image to said sequence S of images.

10. An electronic device for building a mosaic image from a sequence S of images of a hollow organ, said sequence S of images coming from an endoscope inserted inside the hollow organ, the electronic device comprising:
at least one processor; and
a memory storing instructions readable by the at least one processor, which when executed by the at least one processor configure the electronic device to:
select images, from said sequence S of images, delivering a subset of images SC and a reference image I_{ref}^{c} among this subset of images SC;
determine geometric links H between the reference image I_{ref}^{c} previously determined and the images of the subset of images SC; and
build the mosaic image from the reference image I_{ref}^{c}, at least some of the images of the subset of images SC and the geometric links H of these images of the subset of images SC.

11. A non-transitory computer readable medium comprising programme code instructions for execution of a method, when the instructions are executed on a computer, the method comprising:
building a mosaic image from a sequence S of images of a hollow organ, said sequence S of images coming from an endoscope inserted into the hollow organ, the building comprising:
selecting images, from said sequence S of images, delivering a subset of images S_{c} and a reference image I_{ref}^{c} among this subset of images S_{C};
determining geometric links H between the reference image I_{ref}^{c} previously determined and the images of the subset of images SC; and
building the mosaic image from the reference image I_{ref}^{c}, at least some of the images of the subset of images SC and the geometric links H of these images of the subset of images SC.

12. The method for building a mosaic image according to claim 1, comprising receiving the sequence S of images from the endoscope that is inserted into the hollow organ.

13. The method for building a mosaic image according to claim 13, comprising capturing the sequence S of images by the endoscope that is inserted into the hollow organ.
